(19) United States
(12) Patent Application Publication
(10) Pub. No.: US 2009/0091737 A1
(43) Pub. Date: Apr. 9, 2009

(54) LASER MEASURING DEVICE

(75) Inventors: Hong Ki KIM, Yongin (KR); Bae Kyun Kim, Sungnam (KR); June Sik Park, Yongin (KR); Dong Hoon Kang, Yongin (KR); Sang Su Hong, Suwon (KR); Chang Yun Lee, Hwasung (KR); Tak Gyum Kim, Yongin (KR)

Correspondence Address: MCDERMOTT WILL & EMERY LLP, 600 13TH STREET, N.W., WASHINGTON, DC, 20005-3096, US

(73) Assignee: SAMSUNG ELECTRO-MECHANICS CO., LTD.

(21) Appl. No.: 12/196,586

(22) Filed: Aug. 22, 2008

(30) Foreign Application Priority Data
Oct. 5, 2007 (KR) 10-2007-0100361

(51) Int. Cl. G01C 3/08

(52) U.S. Cl. 356/5.01

(57) ABSTRACT

A laser measuring device for precisely measuring a short distance is obtained by adding a relatively simple structure to a TOF laser measuring device that is simple and easily handled. The laser measuring device includes a light emitter, a light receiver and an optical length extender, which increases an optical path of emitted light or incident light.

### CROSS-REFERENCE TO RELATED APPLICATIONS

The present application is based on and claims priority from Korean Application No. 2007-100361, filed on Oct. 5, 2007, the disclosure of which is hereby incorporated by reference herein in its entirety.

### BACKGROUND OF THE INVENTION

1. Field of the Invention

The present invention relates to a laser measuring device, and more particularly, to a laser measuring device for precisely measuring a short distance, which is obtained by adding a relatively simple structure to a Time-Of-Flight (TOF) laser measuring device that is simple and easily handled.

2. Description of the Related Art

Space/object sensors for detecting three dimensional space and object can be divided into contact and non-contact sensors. Contact sensors are generally used in standard environments such as a factory, a building and an industrial site, whereas non-contact sensors can also be flexibly applied to non-standard environments in which various objects are measured.

Non-contact 3D space sensors are a device that acquires data, such as the distance to and the width and height of an object to be measured. The non-contact 3D space sensors radiate a sound wave such as a supersonic wave or a specific frequency of electromagnetic wave such as a laser beam and a Radio Frequency (RF) wave to the object in order to extract amplitude, (round trip) time, a phase value and so on from the wave refracting from the object.

Of these sensors, space sensors using the RF or supersonic wave are merely applicable to the recognition of a space in a short distance (several meters) owing to poor convergence and spatial resolution. That is, these sensors are generally used in limited fields, such as rear distance detection systems and cleaning robots. Conversely, sensors using a laser light source have merits, such as adjustable convergence, a high measuring speed, a high precision and a wide measuring range per unit time, and thus can be applied to various fields such as construction, military, autonomous mobile robots, topographic surveying systems and aerospace industry, which require the ability of measuring an object in a long distance (several kilometers) with a high resolution and a high speed.

The method of measuring the spatial distance to an object using a laser light source can be generally divided into triangulation, Time-Of-Flight (TOF) technology and interferometry.

The triangulation is a method of determining a spatial position of a specific point by analyzing a triangle, which are defined by the specific point and the other two points, the location information of which is already known. In the interferometry, that is, a measuring system using an interferometer, a laser beam is modulated into a predetermined frequency of sine wave, is radiated to an object, and is reflected from the object. The distance to the object is measured using the Optical Path Difference (OPD) between the reflected laser beam and the original laser beam, which is obtained when the beams are recombined after traveling along different optical paths. The TOF technology radiates a laser pulse into a space, detects a returning pulse using a light detecting device, and calculates the time difference between the radiation pulse and the returning pulse, thereby producing the distance to an object.

While the triangulation has excellent precision in short distance measurement, this method is not suitable for long distance measurement since a measurement error increases in proportion to the measuring distance. In the case of the measuring system using an interferometer, the distance to an object is measured based upon the OPD between a reference beam and a measuring (returning) beam. Thus, a reflector capable of reflecting the measuring beam should be attached to the object. That is, a space sensor according to this measuring system has drawbacks such as limited use and high price even though it can measure the object with a very high precision of, for example, several millimeters (mm).

Conversely, a sensor according to the TOF technology can calculate the distance to an object in a relatively simple fashion by detecting a pulse diffracting from the object even if a specific device is not attached to the object. As advantages, the TOF sensor can easily measure a long distance without spatial limitations.

FIGS. 1A to 1C are graphs illustrating the time relationship between a radiation pulse and a received pulse according to the location of an object in a conventional laser measuring device using a laser pulse. Referring to FIG. 1A, the distance to an object is calculated using a time interval Δtₐ, corresponding to the time difference between a pulse radiation time t₁ of a radiation pulse P₁ and a pulse arrival time t₂ of a received pulse P₂. FIG. 1B shows a time interval Δt_{b} between a radiation pulse P₃ and a received pulse P₄, which is shorter than the time interval Δtₐ of FIG. 1A.

Referring to FIG. 1C, a radiation pulse P₅ substantially overlaps a received pulse P₆. This indicates that an object to be measured is close to the laser measuring device. Good performance such as a high resolution is required in order to calculate the distance by separating P₅ and P₆ from each other. That is, since light can travel 30 cm at about 1 ns, high performance for detecting several nanoseconds is required to measure a distance less than 1 m. For more precise measurement, an expensive large size device is required.

Accordingly, it is required to develop an approach to utilize a TOF sensor, which has a simple structure and wide applicability, as a device for measuring an object in a short distance.

### SUMMARY OF THE INVENTION

The present invention has been made to solve the foregoing problems with the prior art, and therefore the present invention provides a laser measuring device for precisely measuring a short distance, which is obtained by adding a relatively simple structure to a TOF laser measuring device that is simple and easily handled.

According to an aspect of the invention, there is provided a laser measuring device, which includes: a light emitter for emitting light; a band pass filter for allowing incident light to pass, the incident light having a wavelength equal with that of the emitted light; a light receiver for receiving the incident light, which is allowed to pass through the band pass filter; and an optical path extender for extending an optical path of at least one of the emitted light and the incident light.

The laser measuring device may further include a vertical scanning mirror for vertically scanning an object to be recognized; and a horizontal scanning mirror for horizontally scanning the object.

The light receiver can receive light that passed through the optical path extender.

The optical path extender may include an optical fiber to extend the optical path. Considering the characteristics of the optical fiber, a condenser lens may be disposed at an input end of the optical path extender, adjacent to the light emitter, and a collimator lens may be disposed at an output end of the optical path extender.

The optical path extender may include at least two optical mirrors to extend the optical path, or include a prism in place of the optical mirrors to extend the optical path. Alternatively, both the optical mirrors and the prism can be used in the optical path extender.

The laser measuring device may further include a controller for producing a distance by acquiring time data of the emitted light and the incident light. The controller may produce the distance by operating the time data, a reference time corresponding to a light traveling time in the extended optical path, and velocity of light.

The laser measuring device of the invention is a TOF measuring device that has a simple structure and is easily handled, and also can use an optical fiber, optical mirrors or a prism to extend the optical path in order to more precisely measure a short distance, thereby ensuring the reliability of a product.

### BRIEF DESCRIPTION OF THE DRAWINGS

The above and other objects, features and other advantages of the present invention will be more clearly understood from the following detailed description, taken in conjunction with the accompanying drawings, in which:

FIGS. 1A to 1C are graphs illustrating the time relationship between a radiation pulse and a received pulse according to the location of an object in a conventional laser measuring device using a laser pulse;

FIG. 2 is a configuration view illustrating a laser measuring device according to an embodiment of the invention;

FIG. 3 is a configuration view illustrating a laser measuring device according to another embodiment of the invention;

FIG. 4 is a configuration view illustrating a laser measuring device according to a further embodiment of the invention;

FIG. 5 is a schematic block diagram illustrating an optical path of light, which is generated by a laser measuring device according to the invention;

FIG. 6 is a graph illustrating the time relationship between a radiation pulse and a received pulse in a laser measuring device according to the invention; and

FIGS. 7 to 11 are configuration views illustrating laser measuring devices according to various embodiments of the invention, which have an optical path extender.

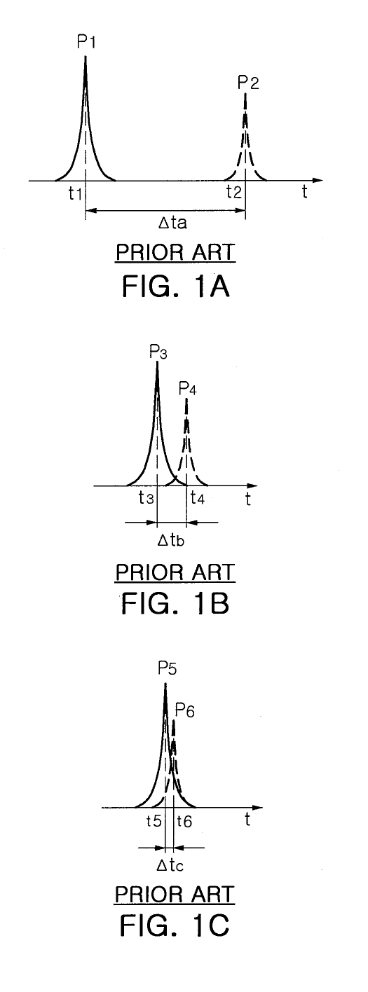

### DETAILED DESCRIPTION OF THE EXEMPLARY EMBODIMENTS

The present invention will now be described more fully with reference to the accompanying drawings, in which exemplary embodiments thereof are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art.

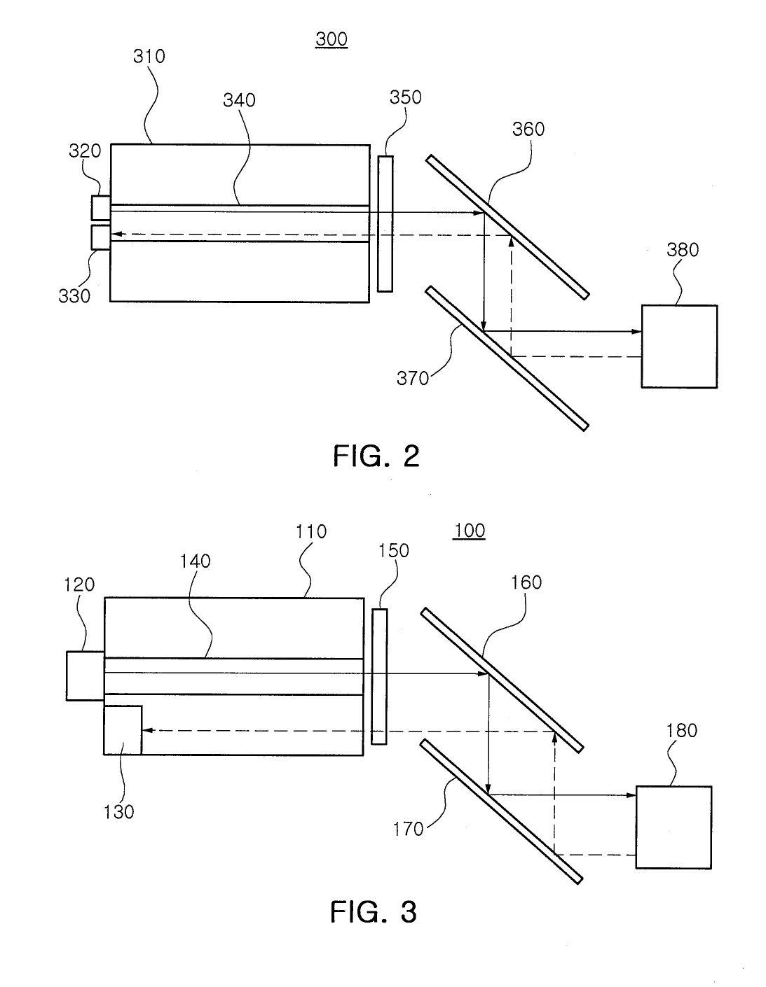

FIG. 2 is a configuration view illustrating a laser measuring device 100 according to an embodiment of the invention. The laser measuring device 100 of this embodiment includes a light emitter 120 for emitting light, a band pass filter 150 for allowing incident light to pass, which has a wavelength the same as that of emitted light, a light receiver 130 for receiving incident light, which is allowed to pass through the band pass filter 150, and an optical path extender 140 for extending an optical path of at least one of emitted light and incident light.

The light emitter 120 includes a light emitting device (not shown), such as a laser diode or a light emitting diode (LED), which can emit a light pulse. While the light emitter 120 can be provided in any position of a body 110 of the laser measuring device, it is desirable that the light emitter 120 be located to emit light in consideration of the position of the light receiver 130 and the optical path extender 140, which will be described later.

A light beam, emitted from the light emitter 120 (hereinafter referred to as “emitted light”), exits the laser measuring device 100, reflects from an object to be measured, and returns through the band pass filter 150. Then, the light receiver 130 receives a light beam, which returns to the laser measuring device 100 (hereinafter referred to as “incident light”).

The band pass filter 150 allows incident light to pass when it has a wavelength the same as that of emitted light, so that object measurement data can be acquired from incident light.

The optical path extender 140 acts to extend the optical path of at least one of emitted light and incident light. Referring to FIG. 2, the optical path extender 140 is located on the optical path of emitted light to extend the same. Accordingly, a time period that emitted light exits the laser measuring device 100 along the optical path extender 140 is increased by a time period that emitted light travels an extended portion of the optical path.

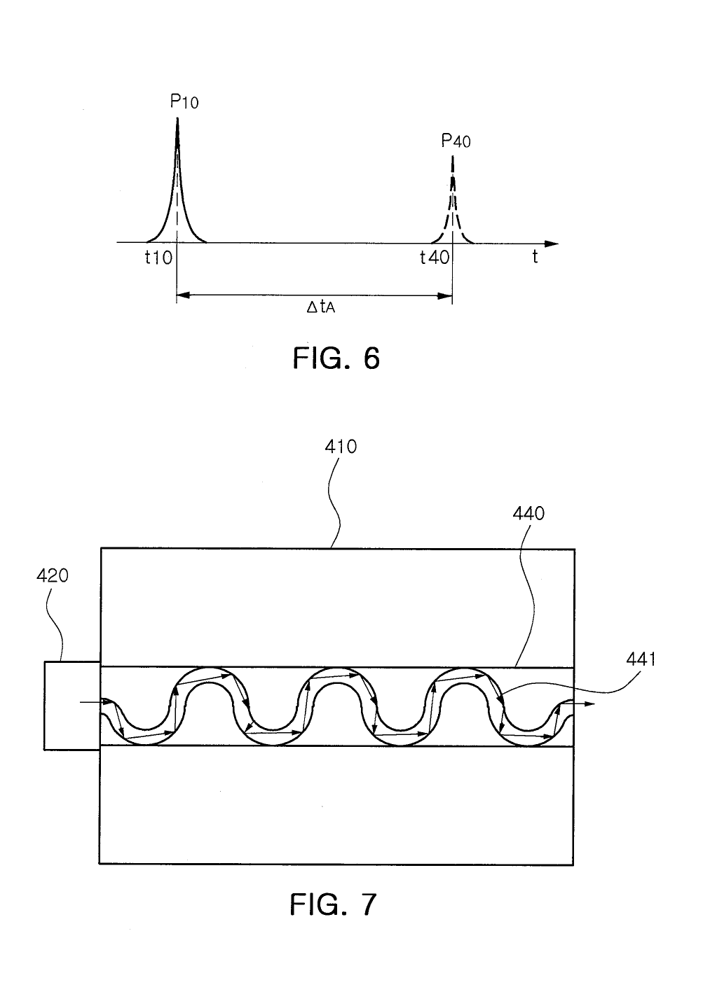

When the laser measuring device 100 measures an object in a short distance, a time period that light travels the distance is very short in view of the velocity of light. Accordingly, the time period that light travels can be measured more precisely if it can be increased by the extended optical path. Details regarding the calculation of the distance will be discussed later with reference to FIGS. 5 and 6.

The optical path extender 140 may be implemented as, for example, an optical fiber, an optical mirror and a prism, which can reflect light in a predetermined direction to deviate from and return to the original optical path. The optical path extender will be described more fully later with reference to FIGS. 7 to 11.

The laser measuring device according to this embodiment of the invention also includes a vertical scanning mirror for vertically scanning an object to be measured and a horizontal scanning mirror for horizontally scanning the object. Accordingly, the laser measuring device 100 of the invention can measure not only the distance to the object but also the horizontal and vertical positions of the object.

The vertical scanning mirror 160 may be implemented as, for example, a galvano mirror, whereas the horizontal scanning mirror may be implemented as, for example, a rotation mirror. The rotation mirror is mounted on a rotary motor, which can rotate the mirror for 360°, in order to send light in a horizontal direction. The galvano mirror can reciprocally move at a predetermined angle about a rotary axis in order to send light in a vertical direction. The vertical scanning mirror 160 may also be provided with an acousto-optical deflector or an electro-optical deflector to increase a vertical scanning range.

FIG. 3 is a configuration view illustrating a laser measuring device according to another embodiment of the invention. In this embodiment, an optical path extender 240 is located on an optical path, along which incident light arrives a light receiver 230. Except for the optical path extender 240, other components including a body 210, a light emitter 220, a light receiver 230, a band pass filter 250, a vertical scanning mirror 260 and a horizontal scanning mirror 270 are substantially the same as those illustrated in FIG. 2, and thus will not be described.

In this embodiment, the optical path extender 240 extends a portion of the optical path inside the body 210, through which incident light propagates to the light receiver 230. Incident light returns to the laser measuring device 200 when emitted light, after exiting the laser measuring device 200, reflects or diffracts from an object to be measured.

As shown in FIGS. 2 and 3, the optical path extender 140, 240 extends the optical path of emitted light or incident (arriving) light. While the extended optical path may promote the ability of measuring an object in a short distance, the optical path extender 140, 240 may limit the location of components. In this invention, the optical path extender 140, 240 can extend the optical path without limiting the location of one of the light emitter 120, 220 and the light receiver 130, 230, thereby enhancing the ability of measuring an object in a short distance.

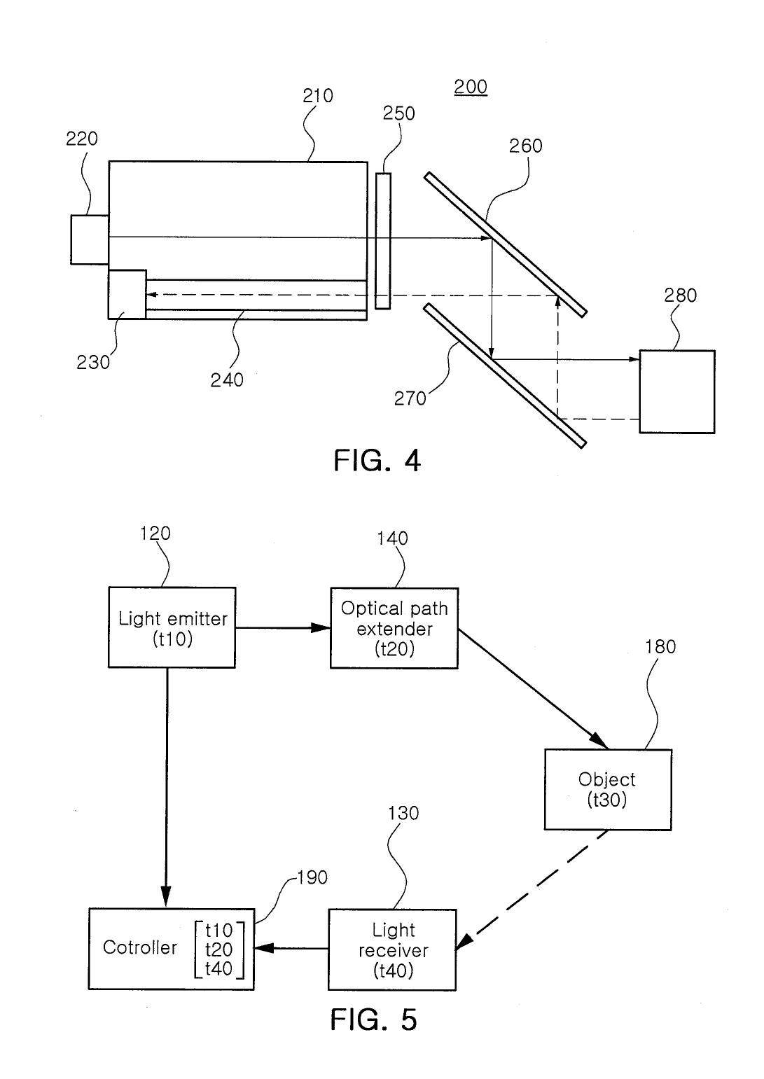

FIG. 4 is a configuration view illustrating a laser measuring device according to a further embodiment of the invention. In this embodiment, an optical path extender 340 is located on optical paths of emitted light and incident light. Except for the location of the optical path extender 340, other components including a body 310, a light emitter 320, a light receiver 330, a band pass filter 350, a vertical scanning mirror 360 and a horizontal scanning mirror 370 are substantially the same as those illustrated in FIG. 2, and thus will not be described.

In this embodiment, the optical path extender 340 extends the optical paths of emitted light and incident (arriving) light in the body 340. This, as a result, can double an optical path that light, emitted from the light emitter 320, travels inside the body 310 before arriving the light receiver 330, thereby making the extension of the optical path more effective.

FIG. 5 is a schematic block diagram illustrating an optical path of light, which is generated by a laser measuring device according to the invention, and FIG. 6 is a graph illustrating the time relationship between a radiation pulse and a received pulse in the laser measuring device according to the invention. Below, a description will be given with reference to FIGS. 5 and 6 together with FIG. 2.

The laser measuring device 100 in FIG. 2 further includes a controller 190 that calculates a distance by acquiring time data from the light receiver 130. The controller 190 calculates the distance by subtracting a reference time, which corresponds to a traveling time of light in the extended optical path, from the time data, which is acquired from the light receiver 130, and operating the subtracted result with the velocity of light. In the following description, time unit will be nanosecond (ns).

As shown in FIG. 5, when the light emitter 120 generates a radiation pulse P10 at a time point t₁₀, the optical path of emitted light is extended by the optical path extender 140. Emitted light travels the optical path extender 140, arrives an object 180 at a time point t₂₀, reflects or diffracts therefrom at a time point t₃₀, and arrives the laser measuring device through the band pass filter (not shown; see 150 in FIG. 2) at a time point t₄₀. Herein, P₄₀ indicates a received pulse, which arrives at the time point t₄₀.

Δt_{A} indicates the time interval between P₁₀ and P₄₀, which includes all time intervals from t₁₀ to t₂₀, from t₂₀ to t₃₀, and from t₃₀ to t₄₀. Here, a portion of the optical path, extended by the optical path extender 140, produces a time difference t₂₀−t₁₀. Subtracting t₂₀−t₁₀ from Δt_{A} produces a time period that light reciprocally travels from the laser measuring device to the object and from the object to the laser measuring device. While a time period that light travels inside the laser measuring device is not considered in the above calculation of a distance, it can be added to the calculation when the object is located in a short distance. Since light travels 30 cm/ns regarding its velocity, the distance to the object is calculated by multiplying 30 (cm) to {Δt_{A}−(t₂₀−t₁₀)}/2.

FIGS. 7 to 11 are configuration views illustrating laser measuring devices according to various embodiments of the invention, which have an optical path extender. In the laser measuring devices shown in FIGS. 7 to 11, only a body, a light emitter and an optical path extender are illustrated in the assumption that only an optical path of emitted light is extended. However, it will be apparent to those skilled in the art that an optical path of incident light can be extended or both the optical path of emitted light and the optical path of incident light can be extended.

Referring to FIG. 7, the optical path extender 440 includes an optical path 441. Considering the characteristics of the optical fiber 441 used in the optical path extender 440, the shape of the optical fiber 441 is not limited, and the length thereof can be extended to a degree that can be allowed by the volume of the optical path extender 140. Furthermore, since the optical fiber 441 is a relatively inexpensive material, the cost of whole parts of the laser measuring device is not greatly influenced even if a large amount of the optical fiber is used. Furthermore, even if another component is present in the body 410 of the laser measuring device, the optical fiber 441 can be freely arranged due to its properties, and thus the optical path can be extended more effectively.

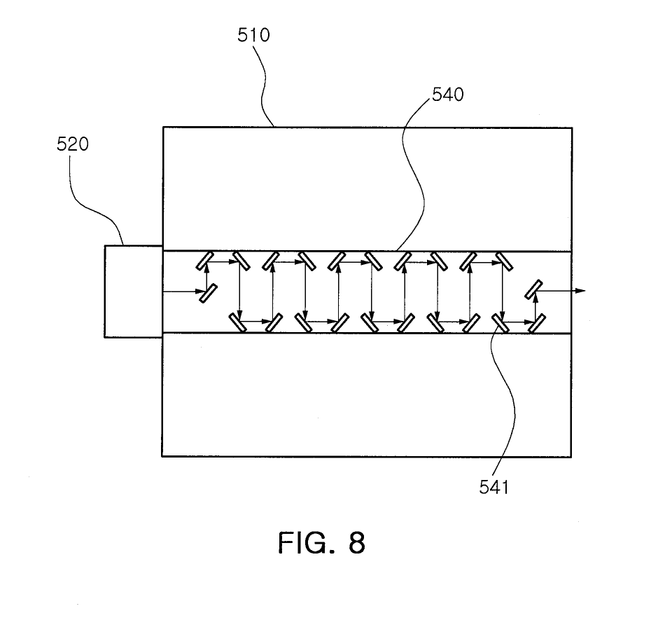

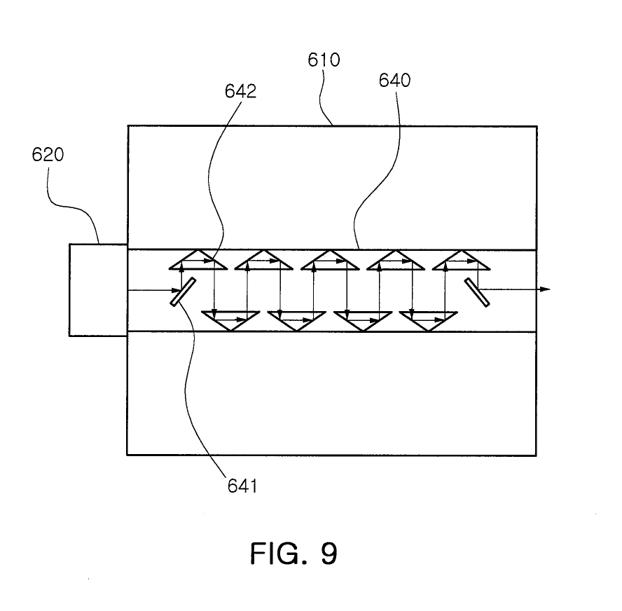

Referring to FIG. 8, the optical path extender 540 includes two or more optical mirrors 541. When the optical mirrors are used as the optical path extender, it is required to correctly align the optical mirrors. The optical mirrors 540 are also applicable since requirements are not a specific path inside the optical path extender 540 but a specific length that emitted light travels.

In the laser measuring device shown in FIG. 9, optical mirrors 641 are used together with prisms 642, which replace some of the optical mirrors shown in FIG. 8. In this embodiment, a fewer number of the prisms are used compared to the optical mirrors shown in FIG. 8, and thus are more easily aligned. While the optical path extender 640 shown in FIG. 9 includes both the optical mirrors 641 and the prisms 642, it will be apparent to those skilled in the art that it can be constructed of only the prisms 642.

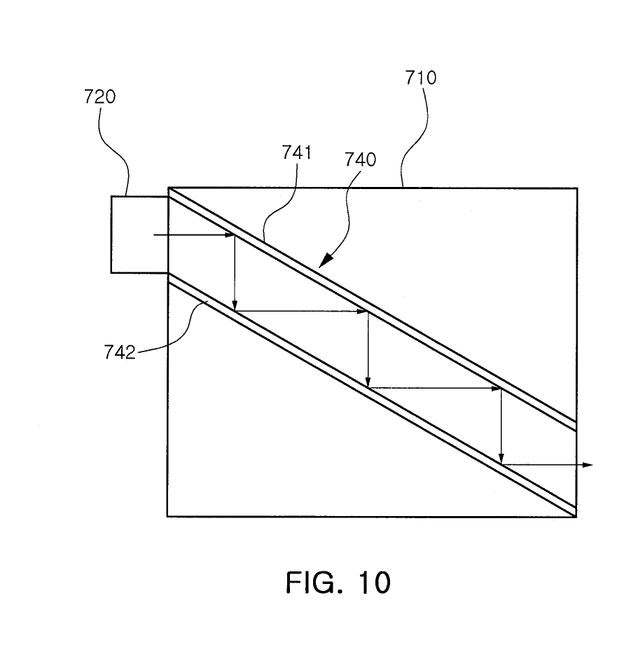

In the laser measuring device shown in FIG. 10, the optical path extender 710 is constructed of a pair of optical mirrors 741 and 742. Since a pair of the optical mirrors 741 and 742 is used, an optical path can be extended by a simpler construction, and be more easily aligned. Furthermore, the ratio of the extension of the optical path can be more simply adjusted by adjusting the inclination of the optical mirror 741 and 742.

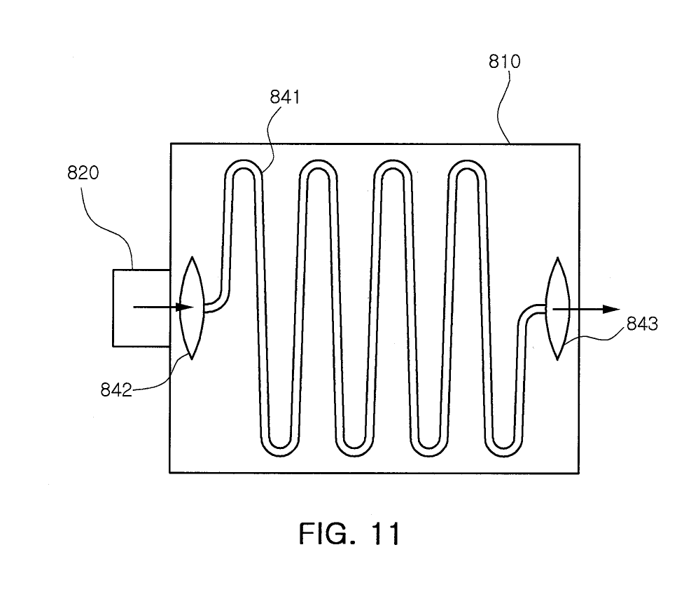

In the laser measuring device of this embodiment as shown in FIG. 11 like the measuring device shown in FIG. 7, the optical path extender 840 is implemented using an optical fiber 841. Here, the optical path extender 840 includes a condenser lens 842 and a collimator lens 843. Considering the characteristics of light that travels in the optical fiber 841, the condenser lens 842 is disposed at an input end of the optical path extender 840, through which light, emitted from a light emitter 820, enters the optical path extender 840, and the collimator lens 843 is disposed at an output end of the optical path extender 840.

While the present invention has been described with reference to the particular illustrative embodiments and the accompanying drawings, it is not to be limited thereto but will be defined by the appended claims. It is to be appreciated that those skilled in the art can substitute, change or modify the embodiments in various forms without departing from the scope and spirit of the present invention.

What is claimed is:

1. A laser measuring device comprising:
a light emitter for emitting light;
a band pass filter for allowing incident light to pass, the incident light having a wavelength equal with that of the emitted light;
a light receiver for receiving the incident light, which is allowed to pass through the band pass filter; and
an optical path extender for extending an optical path of at least one of the emitted light and the incident light.

2. The laser measuring device according to claim 1, further comprising:
a vertical scanning mirror for vertically scanning an object to be recognized; and
a horizontal scanning mirror for horizontally scanning the object.

3. The laser measuring device according to claim 1, wherein the optical path extender comprises an optical fiber.

4. The laser measuring device according to claim 3, further comprising:
a condenser lens disposed at an input end of the optical path extender; and
a collimator lens disposed at an output end of the optical path extender.

5. The laser measuring device according to claim 1, wherein the optical path extender includes at least two optical mirrors.

6. The laser measuring device according to claim 1, wherein the optical path extender comprises at least one prism.

7. The laser measuring device according to claim 1, wherein the optical path extender comprises at least two optical mirrors and at least one prism.

8. The laser measuring device according to claim 1, further comprising:
a controller for producing a distance by acquiring time data of the emitted light and the incident light,
wherein the controller produces the distance by operating the time data, a reference time corresponding to a light traveling time in the extended optical path, and velocity of light.
